(19) United States
(12) Patent Application Publication
(10) Pub. No.: US 2007/0030792 A1
(43) Pub. Date: Feb. 8, 2007

(54) Electronic apparatus having a cylindrical storage device

(76) Inventor: Chi-Hung Chen, Taipei (TW)

Correspondence Address: RABIN & Berdo, PC, 1101 14TH STREET, NW, SUITE 500, WASHINGTON, DC, 20005, US

(21) Appl. No.: 11/445,154

(22) Filed: Jun. 2, 2006

(30) Foreign Application Priority Data
Aug. 2, 2005 (TW) 94126278

(51) Int. Cl. G11B 19/00

(52) U.S. Cl. 369/214

(57) ABSTRACT

An electronic apparatus comprises a cylindrical storage device and a read/write component. The cylindrical storage device has a top surface, a bottom surface and a cylindrical surface. The cylindrical surface connects the top surface and the bottom surface opposite to the top surface. The read/write component is movably disposed near the cylindrical surface for data reading from or writing to the cylindrical surface.

This application claims the benefit of Taiwan application Serial No. 94126278, filed Aug. 2, 2005, the subject matter of which is incorporated herein by reference.

### BACKGROUND OF THE INVENTION

1. Field of the Invention

The invention relates in general to an electronic apparatus having a storage device, and more particularly to an electronic apparatus having a cylindrical storage device.

2. Description of the Related Art

Along with the rapid advance and popularity in the broadcasting of information, the demand for storage device also increases. The development of large-capacity and high-density storage device is crucial to the growth and popularity of products in the industries of information, entertainment, broadcasting, and so on. For example, the digital music player, digital video recorder, digital camera, and game station all require a large-capacity, high-speed, and stable storage device. The most commonly used storage devices are mainly categorized into the magnetic disc drive and the optical disc drive. The magnetic disc drive, which stores data onto the surface of the disc by changing the magnetism, possesses the characteristics of high speed in data reading/writing. The optical disc drive, which records information on the surface of the disc by laser light, is characterized by low unit storage cost and large volume data backup. Both the magnetic disc drive and the optical disc drive use the disc as a storage device. When the disc is in rotation, data are read from or written onto the surface of the disc by a pick-up head or read/write head of the storage device. It is noted that data reading/writing speed must be constant when the data are being read from or written onto the storage device. However, under a constant rotation speed, the rotation speed at the inner tracks of the disc is different from the rotation speed at the outer tracks of the disc. Therefore, the rotation speed at different part of the disc must be adjusted. As a result, the data reading/writing efficiency becomes unstable.

### SUMMARY OF THE INVENTION

It is therefore an object of the invention to provide an electronic apparatus having a cylindrical storage device capable of reading/writing data without changing the rotation speed, so that efficiency stability is maintained.

The embodiment of the invention achieves the above-identified object by providing a cylindrical storage device having a top surface, a bottom surface and a cylindrical surface. The cylindrical surface connects the top surface and the bottom surface opposite to the top surface. The cylindrical surface is used for data reading/writing.

The embodiment of the invention further achieves the above-identified object by providing an electronic apparatus comprising a cylindrical storage device and a read/write component. The cylindrical storage device has a top surface, a bottom surface and a cylindrical surface. The cylindrical surface connects the top surface and the bottom surface opposite to the top surface. The read/write component is movably disposed near the cylindrical surface for data reading from or writing onto the cylindrical surface.

The embodiment of the invention further achieves the above-identified object by providing yet another cylindrical storage device characterized by having a top surface and a bottom surface whose areas are substantially the same, and a cylindrical surface connecting the top surface and the bottom surface. The cylindrical surface is used for data reading/writing.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a disc drive according to a first embodiment of the invention;

FIG. 2 illustrates a reciprocating read/write head in a disc drive of the invention; and

FIG. 3 illustrates a disc drive according to a second embodiment of the invention.

### DETAILED DESCRIPTION OF THE INVENTION

The electronic apparatus having a cylindrical storage device of the invention stores data on a cylindrical surface of the cylindrical storage device to improve the stability in reading/writing data. The electronic apparatus can be a magnetic disc drive, an optical disc drive, or an optical disc writer. Examples of the magnetic disc drive include a hard disc drive having data reading/writing function. Examples of the optical read/write device include an optical disc drive having data reading function. Examples of the optical read/write device include an optical disc writer having data reading/writing function. The invention is exemplified by the disc drive.

### First Embodiment

Referring to FIG. 1, a disc drive according to a first embodiment of the invention is shown. The disc drive 100 comprises a cylindrical storage device and a read/write component. The cylindrical storage device is preferably a cylindrical disc 140 having a cylindrical surface 142, a top surface 144 and a bottom surface 146. Data can be read from or written onto the cylindrical surface 142, the top surface 144 and the bottom surface 146. The cylindrical surface 142 connects the top surface 144 and the bottom surface 146 opposite to the top surface. The read/write component, such as a read/write head 110, is movably disposed above the cylindrical surface 142. The axis 148 penetrates through and projects from the top surface 144 and the bottom surface 146. When the cylindrical disc 140 is indirectly driven by the axis 148 to rotate, the read/write head 110 can read data from or write data onto the cylindrical surface 142.

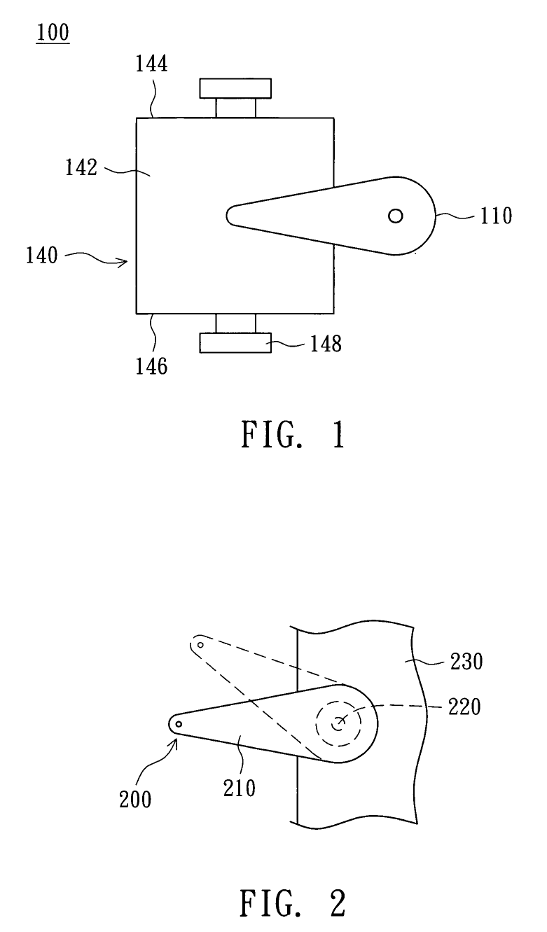

Any one who is skilled in the technology of the present embodiment of the invention will understand that the technology of the present embodiment of the invention is not limited thereto. For example, the disc drive 100 can further have a casing (not shown in the diagram), and the cylindrical disc 140 can be received in the casing. Besides, the read/write head 110 is preferably a reciprocating read/write head. Referring to FIG. 2, a reciprocating read/write head according to a disc drive of the invention is shown. The reciprocating read/write head 200 comprises a transmission arm 210 and a transmission axis 220. The transmission axis 220 is disposed on the casing 230. One end of the transmission arm 210 is connected to the transmission axis 220 for enabling the reciprocating read/write head 200 to reciprocate around the transmission axis 220.

The disc drive of the present embodiment of the invention incorporates the read/write head 110 with the cylindrical disc 140 for reading/writing data. With the data being stored on the cylindrical surface 142 of the cylindrical disc 140 and a constant rotation speed of the cylindrical disc 140 being maintained, the read/write head 110 is capable of reading/writing data with stable efficiency.

### Second Embodiment

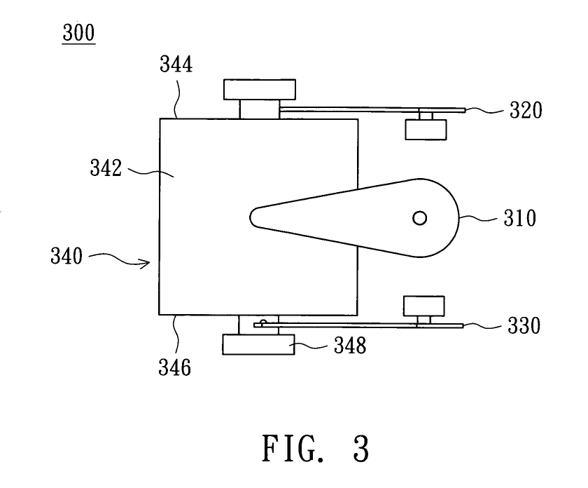

Referring to FIG. 3, a disc drive according to a second embodiment of the invention is shown. The disc drive 300 of the present embodiment differs with the disc drive 100 of the first embodiment in the read/write component. The read/write component of the disc drive 300 comprises a first read/write head 320, a second read/write head 330 and a side read/write head 310, which are movably disposed above a top surface 344, a bottom surface 346 and a cylindrical surface 342, respectively. When the cylindrical disc 340 is indirectly driven by the axis 348 to rotate, the first read/write head 320, the second read/write head 330 and the side read/write head 310 can read data from or write data onto the top surface 344, the bottom surface 346 and the cylindrical surface 342, respectively. At least one of the first read/write head 320, the second read/write head 330 and the side read/write head 310 is a reciprocating read/write head. Other components of the present embodiment are the same with the first embodiment, and are not repeated here.

In addition to the cylindrical surface 342 of the cylindrical disc 340, the data can be stored onto the top surface 344 and the bottom surface 346 of the cylindrical disc 340 according to the present embodiment of the invention. Consequently, the storage capacity is increased and the unit storage cost of the cylindrical disc 340 is reduced.

When the electronic apparatus of the invention is an optical read/write device, such as an optical disc writer having an optical read/write cylinder for instance, the read/write component is an optical read/write head. When the electronic apparatus of the invention is an optical pick-up device, such as an optical disc drive without writing function for instance, the read/write device is an optical pick-up head, and can only read data from an optical cylinder.

The electronic apparatus having a cylindrical storage device disclosed in the above embodiments of the invention provides a cylindrical surface capable of storing data for data reading/writing. The external diameter of the cylindrical storage device being fixed, the external diameters from top to down are of equal distance, so that constant rotation speed of the cylindrical storage device during data reading/writing is achieved, and that the efficiency of the electronic apparatus is stabilized. The disc drive 300 of the second embodiment can dispose multiple read/write heads above the top surface 344 and the bottom surface 346 in addition to the cylindrical surface 342 to increase the storage capacity as well as the read/write speed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus, comprising:
a cylindrical storage device having a top surface, a bottom surface and a cylindrical surface, wherein the cylindrical surface connects the top surface and the bottom surface opposite to the top surface; and
a read/write component movably disposed near the cylindrical surface for data reading from or writing to the cylindrical surface.

2. The electronic apparatus according to claim 1, wherein the cylindrical storage device further comprises an axis, by which the cylindrical storage device is indirectly driven to rotate.

3. The electronic apparatus according to claim 2, wherein the axis penetrates through and projects from the top surface and the bottom surface.

4. The electronic apparatus according to claim 1, wherein the read/write component further comprises a top read/write head, a bottom read/write head and a side read/write head disposed above the top surface, the bottom surface and the cylindrical surface, respectively, and when the cylindrical storage device rotates, the top read/write head, the bottom read/write head and the side read/write head read data from the top surface, the bottom surface and the cylindrical surface, respectively.

5. The electronic apparatus according to claim 4, wherein at least one of the top read/write head, the bottom read/write head and the side read/write head is a reciprocating read/write head.

6. The electronic apparatus according to claim 1, wherein the read/write component is an optical pick-up head.

7. The electronic apparatus according to claim 1, wherein the read/write component is a read/write magnetic head.

8. The electronic apparatus according to claim 1, wherein the apparatus further has a casing, and the cylindrical storage device is received in the casing.

9. The electronic apparatus according to claim 7, wherein the apparatus further comprises:
a transmission axis disposed on the casing; and
a transmission arm whose one end is connected to the transmission axis and whose the other end is connected to the read/write component for enabling the read/write component to reciprocate around the transmission axis.

10. The electronic apparatus according to claim 1, wherein the apparatus is an optical read/write device.

11. The electronic apparatus according to claim 10, wherein the optical read/write device is an optical disc drive.

12. The electronic apparatus according to claim 10, wherein the optical read/write device is an optical disc writer.

13. The electronic apparatus according to claim 1, wherein the apparatus is a disc drive.

14. The electronic apparatus according to claim 13, wherein the apparatus is a hard disc drive.

15. The electronic apparatus according to claim 1, wherein the top surface of the cylindrical storage device has the same area with the bottom surface of the cylindrical storage device.

16. A cylindrical storage device characterized by having a top surface and a bottom surface whose areas are substantially the same, and a cylindrical surface connecting the top surface and the bottom surface, wherein the cylindrical surface is used for data reading/writing.

17. The cylindrical storage device according to claim 16 further comprises an axis, by which the cylindrical storage device is indirectly driven to rotate.

18. The cylindrical storage device according to claim 17, wherein the axis penetrates through and projects from the top surface and the bottom surface.
